(19) United States
(12) Patent Application Publication
(10) Pub. No.: US 2012/0297575 A1
(43) Pub. Date: Nov. 29, 2012

(54) Handle for Tablet Computers

(76) Inventor: Ernesto Garcia, Alexandria, VA (US)

(21) Appl. No.: 13/116,434

(22) Filed: May 26, 2011

(51) Int. Cl. B25G 1/00

(52) U.S. Cl. 16/111.1

(57) ABSTRACT

An external handle for tablet computers. The handle is an accessory that attaches to the back of tablet computers and allows the tablet computer to be rotatable relative to the handle. The handle further contains a locking system that maintains the tablet at a horizontal orientation or a vertical orientation. The handle further contains a cleaner that detaches from the handle and which allows a user to clean fingerprints from a screen of the tablet computer.

### TECHNICAL FIELD

The handle pertains to gripping tablet computers at a horizontal orientation or a vertical orientation. The handle is an accessory that attaches and detaches from the back of a tablet computer either directly or indirectly.

### BACKGROUND OF THE INVENTION

Since the introduction of tablet computers, people have come out with accessories that facilitate handling the tablet computers. Known accessories have included a glove that is attached with hooks and loops to the back of the tablet computers. The glove is rotatable and can be detached from the tablet computer for ease of carrying or storage. Others have introduced a spider that has fours radiating legs attaching to corners of a tablet computer. The spider integrates a cavity that allows one to pass and insert fingers for grabbing the tablet computer while providing support to the tablet computer. The cavity is however set at the center of the tablet computer and is not rotatable nor includes a cleaning feature.

### SUMMARY OF THE INVENTION

The present invention is a rotatable handle that attaches to a tablet computer and eases handling of the tablet computer in a horizontal orientation or in a vertical orientation. The handle is rotatable relative to the tablet computer so as to position the tablet computer in the horizontal orientation or the vertical orientation. The handle contains a locking system that maintains the horizontal orientation or the vertical orientation thus fixing the handle relative to the tablet computer. The handle comprises a housing that functions as a gripper and houses a lint-free cleaner that separates from the handle. The handle provides ease of handling the tablet computer for prolong periods especially as technology advances to making thinner tablet computers.

### BRIEF DESCRIPTION OF THE DRAWINGS

FIG. 1 is an isometric view of the handle.

FIG. 2 is an isometric view of a second portion of the handle.

FIG. 3 is a side view of the second portion of the handle.

FIG. 4 is a front view of the second portion of the handle.

FIG. 5 is a side view of the handle.

FIG. 6 is an isometric view of the first portion of the handle.

FIG. 7 shows the handle installed on a tablet computer and the rotation of the handle into a second position.

FIG. 8 is a side view of the first portion of the handle.

FIG. 9 is a front view of the first portion of the handle.

FIG. 10 is a cross-sectional view of the first portion of the handle shown in FIG. 8.

FIG. 11 is a cross-sectional view of the first portion of the handle shown in FIG. 9.

FIG. 12 is an isometric view of the fixable base, which attaches to the tablet computer.

FIG. 13 is a top view of the fixable base shown in FIG. 12.

FIG. 14 is a cross-sectional view of the fixable base.

FIG. 15 shows a jig tool to facilitate positioning the hooks of a hook and loop system.

FIG. 16 shows the use of the jig tool to position the hooks on a tablet computer.

FIG. 17 shows a front view of the jig tool.

### DETAILED DESCRIPTION

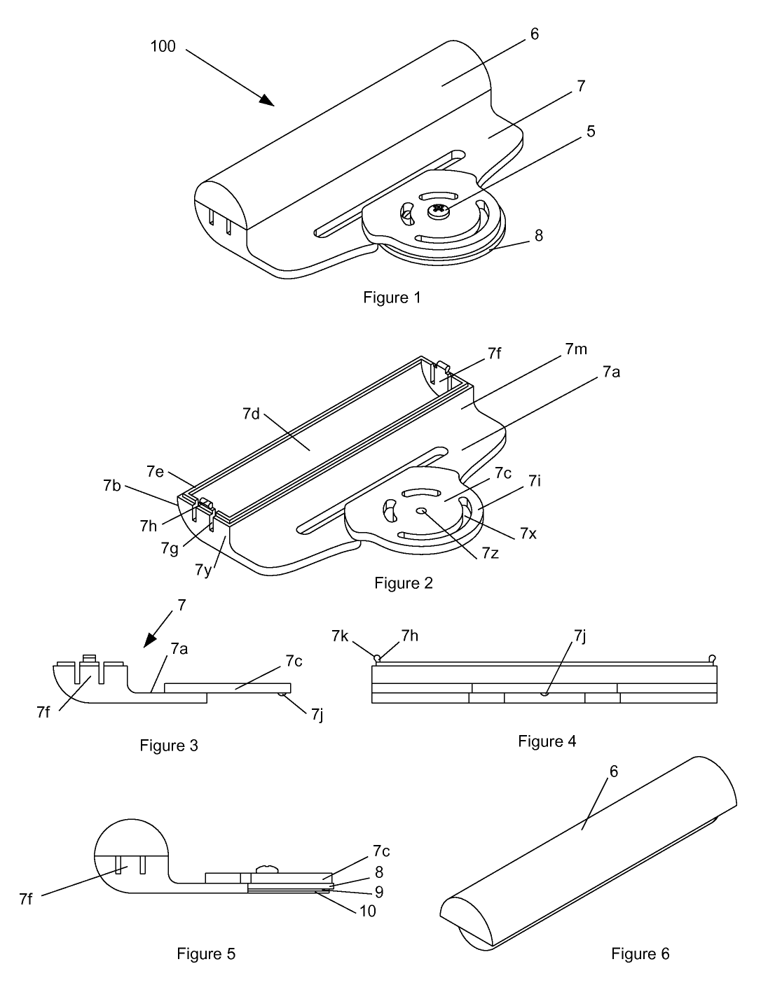

FIG. 1 shows an external handle 100 comprising a first portion 6, a second portion 7, and a fixable base 8. The second portion 7 and the fixable base 8 are pivotally connected with a threaded fastener 5. The first portion 6 and the second portion 7 connect with each other and mate with each other so as to complete a cylinder, which comprises a handle portion for grasping. The second portion 7 includes a second cover 7b, a wing 7a, and an offset portion 7c. The second cover 7b joins to the wing 7a via blend 7m. The second cover 7b contains pair of tabs 7f, a cavity 7d, and a lip 7e. Each of the tabs 7f is formed from a pair of slots 7g that penetrate vertical walls 7y of the second cover 7b. The tabs 7f terminate with a tapered surface 7k, see FIG. 4, which facilitates insertion and locking of the tabs 7f with the first portion 7. The wing 7a contains the offset portion 7c, which serves to pivotally hold the fixing base 8.

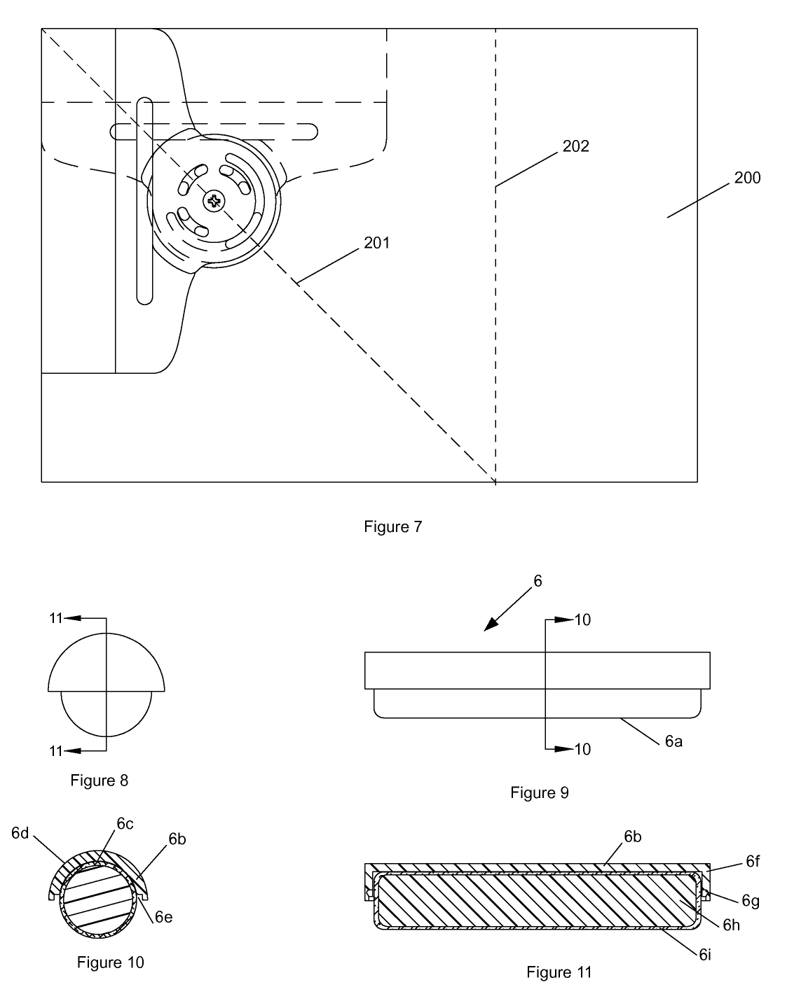

FIG. 2 shows a screw 5 passes through a hole 7z in the offset portion 7c and fastens to the fixable base 8. The offset potion 7c includes an arcuate strip 7i that contains a spherical locking projection 7j. See FIG. 3. The arcuate strip 7i is formed from an arcuate slot 7x on the offset portion 7c. The spherical locking projection 7j projects perpendicular from under the offset portion 7c and flexes with the arcuate strip 7i. The locking projection 7j locks in any of the spherical cavities 8b formed on the fixable base 8 so as to position the handle 100 in a vertical orientation or a horizontal orientation relative to a screen of a tablet computer 200 as shown in FIG. 7. The handle 100 attaches to the back of the screen via hook and loops, 9, 10, as shown in FIG. 5. Of course, other methods of attaching the handle 100 to the back of the screen are envisioned so as to keep the handle permanent to the screen or removable from the screen.

FIGS. 6 and 8-11 show the first portion 6 of the handle 100, which contains a cleaner 6a. The cleaner 6a comprises a micro-fiber fabric 6i that facilitates cleaning glass, and a cylindrical core 6h. The invention contemplates using other types of materials that clean glass or clean clear plastic. The first portion 6 comprises a first cover 6b that houses the cleaner 6a in a cavity 6c. The cleaner 6a is bonded to the cavity 6c or fastened to the cavity using any connecting method. The first cover 6b further contains an external cylindrical surface 6d that facilitates gripping. The first cover 6b further contains a peripheral undercut 6e that mates with the lip 7e so as prevent the first cover 6b from sliding laterally or axially relative to the second cover 7b and to mate the first cover 6b with the second cover 7b. The first cover 6b further contains two vertical walls 6f, which contains locking cavities 6g that receive the locking projections 7h.

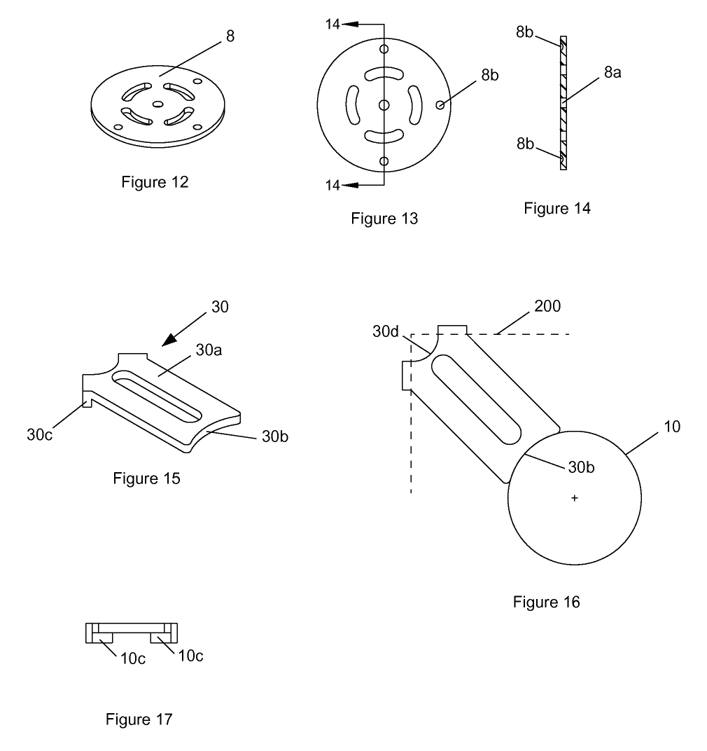

FIGS. 12-14 show the fixable base 8. The fixable base 8 contains a fastening hole 8a and at least three circumferentially spherical cavities 8a which alternatively receive the spherical locking projection 7j. The cavities 8a are positioned at 90 degrees apart. The fixable base 8 contains the hook 8 of the hook and loop system, which allows the handle 100 to be removable from the tablet computer 200. The invention contemplates using the loop 9 of the hook and loop system to be permanently fixed to the back of the table computer or in the case when a cover is used with the tablet computer, fixed to the cover. The fastening hole 8a can be either threaded to receive the threaded fastener 5 or non-threaded so that the threaded fastener 5 forms a thread during assembly thus locking the threaded fastener 5 without slippage. It is contemplated that other fasteners can be utilized such as rivets or fasteners that allow the fixable base 8 to pivot relative to the offset portion 7c.

FIG. 7 shows the location where a pivot axis of the handle 100 is positioned relative to the tablet computer 200. The pivot axis is positioned perpendicular along an imaginary diagonal line 201 from an imaginary square 202 using the dimensions of the tablet computer 200. To facilitate positioning the loop 9 of the hook and loop system along the imaginary diagonal line 201, a jig 30 is utilized. As shown in FIGS. 15-17, the jig 30 comprises a planar backbone 30a, which terminates into a pair of stops 30c at one end and an annular guide 30b at the other end. The stops 30c, when used, abut against the edges of the tablet computer 200. The annular guide 30b provides a location where the loop 10 of the hook and loop system abuts so that the loop 10 is bonded to the tablet computer as seen in FIG. 16. The jig 30 further contains a cutout 30d that separates the stops at 90 degrees from each other and also clears the jig 30 from hitting the corner of the tablet computer 200.

The invention uses a hook and loop system or alternatively can use a permanent fastening system to fix the handle 100 to the tablet computer. The first portion 6, the second portion 7, the fastener 5, and the jig 30 can be made from any known material. The core 6h although being made from solid plastic can also be made with foam so as to cushion forces during cleaning, or be made hollow. The spherical projection 7j on the offset portion 7c and the spherical cavities 8b on the fixable base 8 can be reversed such that the spherical cavities 8b are on the offset portion 7c and the spherical projection 7j is on the fixable base 8. Further, although three spherical cavities 8b are shown, the invention contemplates using at least two or many more. Furthermore, the invention contemplates integrating the fixed portion 8 into the tablet computer 200 such that there is no need to bond or separately fasten the fixed portion 8 to the tablet computer 200 but rather makes part of the tablet computer or in the case where a protective cover for the tablet computer is used, integrating the fixed portion 8 with the protective cover.

1. A handle comprising a first portion and a second portion housing a cleaner in a cavity in each of the first portion and the second portion, wherein the first portion and the second portion are lockable together, and the first portion contains a wing portion having a fixable base being rotatable relative to the second portion at a pivot axis.

2. The handle of claim 1, wherein the first portion contains an arcuate strip formed from an arcuate slot; the arcuate strip contains a spherical projection projecting perpendicular from the arcuate strip and being parallel to the pivot axis; the fixable base comprises at least two spherical cavities circumferentially distributed to receive the spherical projection.

3. The handle of claim 2, wherein the two spherical cavities are 90 degrees apart.

4. The handle of claim 3, wherein another spherical cavity is on the fixable base and located opposite one of the two spherical cavities to be 180 degrees apart.

5. The handle of claim 2, wherein the wing contains an offset portion containing a fastening hole, the arcuate strip, and the arcuate slot.

6. The handle of claim 1, wherein the fixable base contains a fastening hole receiving a fastener.

7. The handle of claim 1, wherein the fixable base contains a hook and loop fastening system.

8. The handle of claim 1, wherein the cleaner comprises a core and a fabric, wherein the fabric surrounds the core; and the cleaner is fixed to the first portion of the handle in the cavity.

9. The handle of claim 1, wherein the first portion contains a first cover comprising a pair of locking cavities; the second portion contains a second cover comprising a pair of tabs each having a locking projection mating with the locking cavities in the first cover; wherein the first cover further comprises a peripheral undercut mating with a lip in the second cover.

10. The handle of claim 9, wherein each of the tabs is formed from slots extending through vertical walls of the second cover.

11. The handle of claim 10, wherein the first cover comprises a semi-cylindrical exterior surface.

12. The handle of claim 1, in combination with a jig and a hook and loop fastening system, wherein the jig comprises a backbone having at one end a pairs of stops at 90 degrees from each other, and on an opposite end an arcuate guide so as to guide placement of a hook or a loop of the hook and loop fastening system.

13. The handle of claim 12, wherein a cutout separates the stops.
